(19) United States
(12) Patent Application Publication
(10) Pub. No.: US 2020/0364786 A1
(43) Pub. Date: Nov. 19, 2020

(54) METHOD FOR DETERMINING OPTIMAL WEIGHT VECTOR OF CREDIT RATING BASED ON MAXIMUM DEFAULT IDENTIFICATION ABILITY MEASURED BY APPROACHING IDEAL POINTS

(71) Applicant: DALIAN UNIVERSITY OF TECHNOLOGY, Dalian, Liaoning (CN)

(72) Inventors: Guotai CHI, Dalian, Liaoning (CN); Hongxi LI, Dalian, Liaoning (CN); Ying ZHOU, Dalian, Liaoning (CN)

(21) Appl. No.: 16/961,168

(22) PCT Filed: Jan. 22, 2018
(86) PCT No.: PCT/CN2018/073568

§ 371 Date: Jul. 9, 2020

(51) Int. Cl. G06Q 40/02; G06F 16/215; G06F 16/25; G06N 20/00; G06N 5/04; G06F 17/18

(52) U.S. Cl. CPC G06Q 40/025; G06F 16/215; G06F 17/18; G06N 20/00; G06N 5/04; G06F 16/258

(57) ABSTRACT

A method for determining optimal weight vector of credit rating based on the maximum default identification ability measured by approaching ideal points is disclosed. The minimum algebraic sum of the Euclidean distances from credit scores of a non-default enterprise to a positive ideal point and the minimum algebraic sum of the Euclidean distances from credit scores of a default enterprise to a negative ideal point are taken as the first objective function, and the lowest dispersion degree of the “distances from scores of a non-default enterprise to a positive ideal point” and the lowest dispersion degree of the “distances from scores of a default enterprise to a negative ideal point” are taken as the second objective function to construct multi-objective programming functions and derive a group of optimal weights of a credit rating equation.

### TECHNICAL FIELD

The present invention provides a method for determining optimal weight vector of credit rating indexes, which makes the default identification ability of a credit rating system the maximum, and belongs to the technical field of credit service.

### BACKGROUND

Credit rating has an extremely important impact on economy and society today, whether it is sovereign credit rating, enterprise credit rating, bank credit rating or personal credit rating. If a credit rating result is not reasonable and default risk cannot be accurately assessed, investors and the public will be misled. The impact thereof can be as small as causing the bankrupt of banks and enterprises, or as big as triggering a financial crisis and even the disorder of the whole economy and society. A reasonable credit rating system should have a strong default identification ability, be able to effectively distinguish between a default customer and a non-default customer, and accurately identify a customer with a high default risk.

Weighting indexes and calculating credit scores are indispensable links in credit rating.

A credit rating equation is a function of index data and weight vectors, so that the values of index weights and the structure of the weight vectors are inevitably related to rating results.

It is self-evident that if different weights are given to the same group of indexes, the rating results will be quite different. Therefore, whether the weight vectors are reasonable is a key factor that determines whether the rating results can accurately identify the default risk.

The existing studies on credit rating weighting can be divided into the following three categories:

The first is subjective weighting based on expert judgment. “An enterprise credit rating method” with the patent No. of 201710669426.X and “a credit rating method based on analytic hierarchy process” with the patent No. of 201410334653.3 of the National Intellectual Property Administration, PRC use AHP (analytic hierarchy process) to determine multi-level rating index weights according to an expert judgment matrix and calculate enterprise credit scores.

The second is objective weighting based on measurement statistics, artificial intelligence and other methods. “A method and device for employee credit rating and application, and electronic equipment” with the patent No. of 201710428343.1 of the National Intellectual Property Administration, PRC establishes a logistic regression model of credit rating, and uses the maximum likelihood estimation algorithm to calculate the weight corresponding to each index. “An enterprise credit rating method based on deep learning” with the patent No. of 201511031192.3 of the National Intellectual Property Administration, PRC uses the deep learning algorithm to tune the index weights and make cognition consistent with generation. “Consumer behaviors at lender level” with the U.S. Pat. No. 9,898,779 of the United States Patent and Trademark Office uses a statistical regression analysis method to weight the indexes and evaluate the credit risk of consumers. “Methods and systems for automatically generating high quality adverse action notifications” with the patent No. of WO/2014/121019 of the World Intellectual Property Organization uses the genetic algorithm to weight and construct a credit rating model, and identify the default risk of lenders.

The third is a subjective and objective combination weighting method. “An enterprise credit rating method and system based on subjective and objective weighting multi-model combination verification” with the patent No. of 201611001902.2 of the National Intellectual Property Administration, PRC uses a method of combining subjective and objective weighting of the indexes to conduct enterprise credit rating and Kendall consistency inspection.

The above-mentioned subjective weighting does not reflect the correlation between the index weights and the default status, nor the correlation between the rating result and the actual default status.

The above-mentioned objective weighting reflects the correlation between the index weights and the default status, but does not reflect the correlation between the rating result and the actual default status.

In fact, the credit rating is determined by the credit rating result of customer credit scores. If the internal relation between the weight vectors and the accuracy of the rating result is broken, then the weights are not optimal no matter how determined.

The present invention constructs multi-objective programming functions by a method of approaching ideal points with the rating result of a bad default customer approaching the lowest score and the scores of a good non-default customer approaching the highest score, and derive a group of optimal weights of a credit rating equation in the extreme condition of maximum default identification ability for credit scores, so as to ensure that the default and non-default customers can be significantly distinguished by the rating results, i.e., the score values of the credit rating equation.

### SUMMARY

The purpose of the present invention is to provide a method for determining optimal weight vector, which makes the default identification ability of a credit rating result the maximum.

The technical solution of the present invention is: A method for determining optimal weight vector of credit rating based on the maximum default identification ability measured by approaching ideal points, wherein a positive ideal point is defined as a score obtained by weighting the maximum value of each index and represents the highest score; a negative ideal point is defined as a score obtained by weighting the minimum value of each index and represents the lowest score;

The minimum algebraic sum of the Euclidean distances from credit scores of a non-default enterprise to a positive ideal point and the minimum algebraic sum of the Euclidean distances from credit scores of a default enterprise to a negative ideal point are taken as the first objective function, and the lowest dispersion degree of the “distances from scores of a non-default enterprise to a positive ideal point” and the lowest dispersion degree of the “distances from scores of a default enterprise to a negative ideal point” are taken as the second objective function to construct multi-objective programming functions and derive a group of optimal weights of a credit rating equation, and guarantee that the rating result of the credit rating equation is that a non-default enterprise has the highest score and a default enterprise has the lowest score, thus minimizing the overlap between the two types of samples;

The specific steps are as follows:

### Step 1: Constructing a Credit Risk Evaluation Index System

First, removing redundant indexes that reflect information redundancy from mass-selection indexes through partial correlation analysis; and then, selecting indexes with an ability to significantly distinguish a default status from an index system retained after the above screening through Probit regression to obtain the credit risk evaluation index system;

The construction of the credit risk evaluation index system is the foundation of the subsequent weighting and construction of the credit rating equation, and has a plurality of determination methods;

### Step 2: Importing Data

Importing index data with a significant distinguishing ability in step 1 and customer default status (1 for a default customer and 0 for a non-default customer) into an Excel file; standardizing the imported index data and converting the imported index data into data within the interval of [0,1] to eliminate the influence of dimension;

### Step 3: Constructing a Distance Function

Step 3.1, determining a positive ideal point and a negative ideal point: the positive ideal point represents a score obtained by weighting the maximum value of each index, i.e., the maximum value of the credit scores; since the maximum value after standardization of all index data is 1, the maximum value of the credit scores is 1, i.e., the positive ideal point S⁺=1;

The negative ideal point represents a score obtained by weighting the minimum value of each index, i.e., the minimum value of the credit scores; since the minimum value after standardization of all index data is 0, the minimum value of the credit scores is 0, i.e., the negative ideal point S⁻=0;

Step 3.2, constructing the distance function: constructing a function

$${D}_{k}^{+} = d ( {S}_{k}^{( 0 )} , {S}^{+} ) = {( {\sum }_{j = 1}^{m} {w}_{j} {x}_{kj}^{( 0 )} - {S}^{+} )}^{2}$$

of the distances from credit scores Sₖ⁽⁰⁾ of a non-de^{f}ault enterprise to the positive ideal point S⁺; wherein wⱼ is an index weight and a decision variable to be solved, xₖⱼ⁽⁰⁾ is the standardized index data of a non-default ente^{r}prise in step 2, and S⁺ is the positive ideal point determined in step 3.1;

Constructing a function

$${D}_{l}^{-} = d ( {S}_{l}^{( 1 )} , {S}^{-} ) = {( {\sum }_{j = 1}^{m} {w}_{j} {x}_{lj}^{( 1 )} - {S}^{-} )}^{2}$$

of the distances from credit scores Sₗ⁽¹⁾ of a default enterprise to the negative ideal point S⁻; wherein xᵢⱼ⁽¹⁾ is the standardized index data of a default enterprise in step 2, and S⁻ is the negative ideal point determined in step 3.1;

### Step 4: Constructing the First Objective Function

Constructing an objective function 1 according to the minimum algebraic sum of the Euclidean distances Dₖ⁺ from credit scores of a non-default enterprise to a positive ideal point and the minimum algebraic sum of the Euclidean distances Dₗ⁻ from credit scores of a default enterprise to a negative ideal point, i.e.:

$$obj 1 \text{:} min {\sum }_{k = 1}^{{n}_{0}} {D}_{k}^{+} + C {\sum }_{l = 1}^{{n}_{1}} {D}_{l}^{-} \qquad ( 1 )$$

wherein n₀ is the number of non-default enterprises, C is a penalty coefficient, and n₁ is the number of default enterprises;

The reason for introducing the “penalty coefficient C” in formula (1) is: the number of non-default enterprises n₀ in the first summation term

$${\sum }_{k = 1}^{{n}_{0}} {D}_{k}^{+}$$

is much larger than the number of default enterprises n₁ in the second summation term

$${\sum }_{l = 1}^{{n}_{1}} {D}_{l}^{-} ;$$

the first summation term is much more important in objective function 1 than the second summation term as the value is relatively large, thus causing the problem of unbalanced samples;

Therefore, by introducing the penalty coefficient C, the ratio of the importance of the first term

$${\sum }_{k = 1}^{{n}_{0}} {D}_{k}^{+}$$

to that of the second term

$$C {\sum }_{l = 1}^{{n}_{1}} {D}_{l}^{-}$$

in formula (1) becomes n₀:C×n₁=n₀:(n₀/n₁)×n₁=1:1; and the summation distances of the non-default and default samples in formula (1) are equally close to the minimum, thus solving the problem of unbalanced samples;

Constructing a programming model by taking formula (1) as the first objective function to derive a group of optimal weight vector of a credit rating equation; and guaranteeing that the rating result of the credit rating equation makes a non-default enterprise have the highest score and a default enterprise have the lowest score, and that the default and non-default customers can be significantly distinguished by the credit scores;

### Step 5: Constructing the Second Objective Function

Constructing the second objective function through the lowest dispersion degree of the “distances Dₖ⁺ from scores of a non-default enterprise to a positive ideal point” and the lowest dispersion degree of the “distances Dₗ⁻ from scores of a default enterprise to a negative ideal point”, i.e.:

$$obj 2 \text{:} min \sqrt{VAR ( {D}_{k}^{+} ) + VAR ( {D}_{k}^{-} )} = \sqrt{{\sum }_{k = 1}^{{n}_{0}} {( {D}_{k}^{+} - {\overline{D}}^{+} )}^{2} + {\sum }_{l = 1}^{{n}_{1}} {( {D}_{l}^{-} - {\overline{D}}^{-} )}^{2}}$$

wherein D̅⁺ is the average value of the distances Dₖ⁺ from scores of a non-default enterprise to a positive ideal point, and D̅⁻ is the average value of the distances Dₗ⁻ from scores of a default enterprise to a negative ideal point;

Constructing a programming model by taking formula (2) as the second objective function to derive optimal weight vector of a credit rating equation; and guaranteeing that the rating result of the credit rating equation makes the scores of a default enterprise and a non-default enterprise have the lowest dispersion degree within respective group, thus minimizing the overlap between the two types of samples;

The difference between the first objective function and the second objective function is that the first objective function ensures that a non-default enterprise has the highest score and a default enterprise has the lowest score, while the second objective function minimizes the overlap between the scores of a default enterprise and a non-default enterprise;

### Step 6: Constructing Constraints

Taking that “the sum of all index weights is 1, i.e.,

$${{\sum }_{j = 1}}^{m} {w}_{j} = {1}^{″}$$

and “the index weights are not negative, i.e., wj≥0” as two constraints;

In the method, multi-objective programming models are constructed through the first objective function of step 4, the second objective function of step 5 and the two constraints; and optimal weight vector of a credit rating equation are derived, making the credit rating result satisfy that the scores of a non-default enterprise gather near the positive ideal point and the scores of a default enterprise gather near the negative ideal point, thus the gap between the scores of the two types of enterprises is maximized;

### Step 7: Solving the Optimal Weight Vector

Linearly weighting the first objective function formula (1) and the second objective function formula (2) in the multi-objective programming models at a ratio of 1:1 to obtain a single-objective function programming model; keeping the constraints unchanged, and solving the single-objective programming model by a simplex method to obtain the decision variable “a group of weight vectors W*=(w₁*, w₂*, . . . , wₘ*)”; the weight solution result is directly displayed in an Excel interface;

### Step 8: Calculating Credit Rating Scores

Using the weight solution result wⱼ* of step 4 and the standardized index data xᵢⱼ of step 2 to linearly weight and construct the credit rating equation, and calculating the credit scores

$${S}_{i} = {\sum }_{j = 1}^{m} {w}_{j}^{*} {x}_{ij} .$$

The present invention has the following advantageous effects that:

First, the present invention provides a method for deriving optimal weight vector based on the maximum default identification ability of credit scores. The weighting method of the present invention can guarantee that the credit scores of the rating equation satisfy that a non-default enterprise has the highest score and a default enterprise has the lowest score, making the default and non-default customers distinguished by the credit scores to the maximum extent.

This function is realized due to the construction concept of the objective function formula (1), i.e., deriving weights by “approaching ideal points”. The weights that satisfy the objective function formula (1) can certainly make the scores of a non-default enterprise and a default enterprise polarized, with the former being the highest and the latter being the lowest.

Second, the weighting method of the present invention can guarantee that the credit scores of the rating equation satisfy that the overlap between non-default and default enterprises is minimized and the two types of enterprises are least likely to mix, making the possibility of misjudgment with “default judged as non-default” and “non-default judged as default” minimized.

This function is realized due to the construction concept of the objective function formula (2), i.e., deriving weights by “the lowest dispersion degree”. The weights that satisfy the objective function formula (2) can certainly make the scores of a non-default enterprise and a default enterprise have the lowest dispersion degree within respective group, thus avoiding the mixing of the scores of default and non-default enterprises to the maximum extent.

Third, by deriving weights and calculating credit scores by the present invention, the default risk of a loan or debt is evaluated more reasonably, which enables commercial banks, creditors, the general public and other investors to understand the default status of debts such as bonds and loans and make investment decisions.

Fourth, the weighting model of the present invention has the function of index selection. When the solved index weight wⱼ=0, it indicates that the index has no effect on “distinguishing the scores of a default enterprise from the scores of a non-default enterprise” and can be deleted to achieve the purpose of index selection.

### DESCRIPTION OF DRAWINGS

FIG. 1 is a schematic diagram of credit scores of default and non-default enterprises.

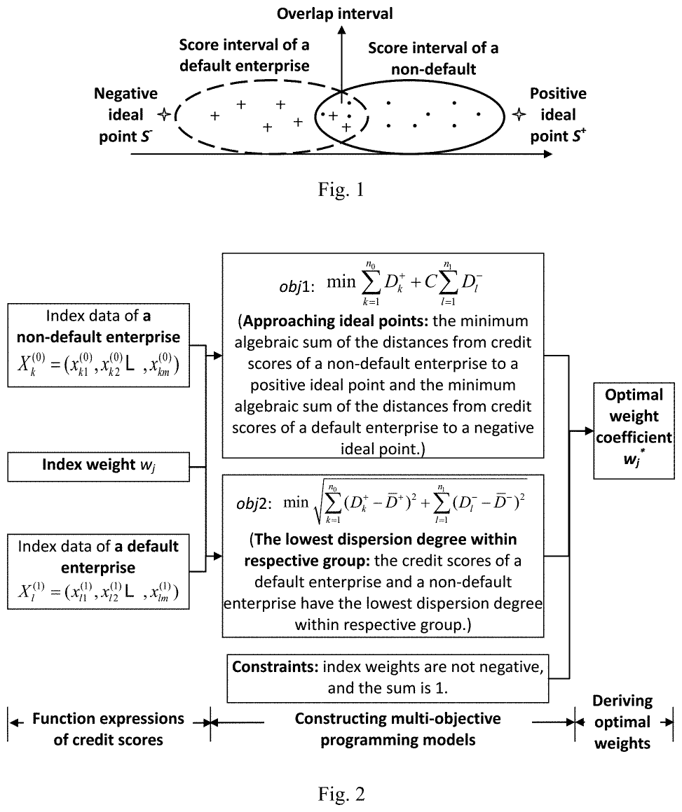

In FIG. 1, the solid line circle represents the credit score interval of a non-default enterprise, the dashed line circle represents the credit score interval of a default enterprise, and the middle part is the overlap interval of the two. The geometric meaning of the first objective function formula (1) is to make the solid line circle where a non-default enterprise is located in FIG. 1 closest to the positive ideal point S⁺ on the right, and the dashed line circle where a default enterprise is located closest to the negative ideal point S on the left. The geometric meaning of the second objective function formula (2) is to minimize the overlap area in the middle part of FIG. 1.

FIG. 2 is a weighting principle based on maximum default identification ability measured by approaching ideal points.

### DETAILED DESCRIPTION

Specific embodiments of the present invention are further described below in combination with accompanying drawings and the technical solution.

The purpose of the present invention is to provide a method for determining optimal weights, which makes the default identification ability of a credit rating result the maximum.

The purpose of the present invention is realized by the following technical solution:

The minimum algebraic sum of the Euclidean distances from credit scores of a non-default enterprise to a positive ideal point and the minimum algebraic sum of the Euclidean distances from credit scores of a default enterprise to a negative ideal point are taken as the first objective function, and the lowest dispersion degree of the “distances from scores of a non-default enterprise to a positive ideal point” and the lowest dispersion degree of the “distances from scores of a default enterprise to a negative ideal point” are taken as the second objective function to construct multi-objective programming functions and derive a group of optimal weights of a credit rating equation.

An empirical analysis of the solution of the present invention is conducted with the data of 1814 loans to small industrial enterprises distributed in 28 cities including Beijing, Tianjin, Shanghai and Chongqing of a regional commercial bank of China as empirical samples. Among the samples, 1799 are non-default samples, and 15 are default samples. The specific steps are as follows:

### Step 1: Constructing a Credit Risk Evaluation Index System

First, removing redundant indexes that reflect information redundancy from mass-selection indexes through partial correlation analysis. Then, selecting indexes with an ability to significantly distinguish a default status from an index system retained after the above screening through Probit regression to obtain the credit risk evaluation index system.

The credit risk evaluation index system is shown in Column 2 of Table 1.

TABLE 1
Credit Risk Evaluation Index System and Index Weights

| (1) S/N | (2) Index | (3) Weight wⱼ* |
|---|---|---|
| 1 | X₁ Asset-Liability Ratio | 0 |
| 2 | X₂ Quick Ratio | 0.1 |
| . . . | . . . | . . . |
| 14 | X₁₄ Urban Per Capita Disposable | 0.314 |
| | Income | |
| 15 | X₁₅ Years of Experience in Relevant | 0.012 |
| | Industry | |
| . . . | . . . | . . . |
| 19 | X₁₉ Age | 0.098 |
| 20 | X₂₀ Time Served in This Position | 0.01 |
| . . . | . . . | . . . |
| 24 | X₂₄ Score of Mortgage and Pledge | 0.065 |
| | Guarantee | |

The construction of the credit risk evaluation index system is the foundation of the subsequent weighting and construction of the credit rating equation, and has a plurality of determination methods.

### Step 2: Importing Data

Importing index data and customer default status (1 for a default customer and 0 for a non-default customer) into an Excel file. Standardizing the imported index data and converting the imported index data into data within the interval of [0,1] to eliminate the influence of dimension.

### Step 3: Constructing Multi-Objective Programming Models

Step 3.1: determining a positive ideal point and a negative ideal point. The positive ideal point is the maximum value of the credit scores; since the maximum value after standardization of all index data is 1, the maximum value of the credit scores is 1, i.e., the positive ideal point S⁺=1. The negative ideal point is the minimum value of the credit scores; since the minimum value after standardization of all index data is 0, the minimum value of the credit scores is 0, i.e., the negative ideal point S⁻=0.

Step 3.2: constructing a distance function. Substituting the standardized index data xₖⱼ⁽⁰⁾ of a non-default enterprise in step 2 and the positive ideal point S⁺=1 of step 3.1 into a formula

$${D}_{k}^{+} = d ( {S}_{k}^{( 0 )} , {S}^{+} ) = {( {\sum }_{j = 1}^{m} {w}_{j} {x}_{kj}^{( 0 )} - {S}^{+} )}^{2}$$

to obtain a function of the distances from credit scores of a non-default enterprise to the positive ideal point.

Substituting the standardized index data xₗⱼ⁽¹⁾ of a default enterprise in step 2 and the negative ideal point S⁻=0 of step 3.1 into a formula

$${D}_{l}^{-} = d ( {S}_{l}^{( 1 )} , {S}^{-} ) = {( {\sum }_{j = 1}^{m} {w}_{j} {x}_{lj}^{( 1 )} - {S}^{-} )}^{2}$$

to obtain a function of the distances from credit scores of a default enterprise to the negative ideal point.

### Step 4: Constructing the First Objective Function

Constructing an objective function 1 by the minimum algebraic sum of the “Euclidean distances Dₖ⁺ from credit scores of a non-default enterprise to a positive ideal point” and the minimum algebraic sum of the “Euclidean distances Dₗ⁻ from credit scores of a default enterprise to a negative ideal point” determined in step 3.2, i.e., obj1:

$$min {\sum }_{k = 1}^{{n}_{0}} {D}_{k}^{+} + C {\sum }_{l = 1}^{{n}_{1}} {D}_{l}^{-} .$$

Wherein n₀ is the number of non-default enterprises, and n₁ is the number of default enterprises. C is a penalty coefficient introduced for solving the problem of unbalanced samples, and C=n₀/n₁.

Constructing a programming model by the objective function 1 to derive optimal weight vector of a credit rating equation. Guaranteeing that the rating result of the credit rating equation makes a non-default enterprise have the highest score and a default enterprise have the lowest score. The geometric meaning of the objective function 1 is to make the solid line circle where a non-default enterprise is located in FIG. 1 closest to the positive ideal point S⁺ on the right, and the dashed line circle where a default enterprise is located closest to the negative ideal point S⁻ on the left.

### Step 5: Constructing the Second Objective Function

Constructing an objective function 2 by the lowest dispersion degree of the “distances Dₖ⁺ from scores of a non-default enterprise to a positive ideal point” and the lowest dispersion degree of the “distances Dₗ⁻ from scores of a default enterprise to a negative ideal point” determined in step 3.2, i.e., obj2:

$$min \sqrt{{\sum }_{k = 1}^{{n}_{0}} {( {D}_{k}^{+} - {\overline{D}}^{+} )}^{2} + {\sum }_{l = 1}^{{n}_{1}} {( {D}_{l}^{-} - {\overline{D}}^{-} )}^{2}} .$$

Wherein D̅⁺ is the average value of the distance function Dₖ⁺ determined in step 3.2, and D̅⁻ is the average value of the distance function Dₗ⁻ determined in step 3.2.

Constructing a programming model by the objective function 2 to derive optimal weight vector of a credit rating equation. Guaranteeing that the rating result of the credit rating equation makes the scores of a default enterprise and a non-default enterprise have the lowest dispersion degree within respective group, thus minimizing the overlap between the two types of samples. The geometric meaning of the objective function 2 is to minimize the overlap area in the middle part of FIG. 1.

The difference between the objective function 1 and the objective function 2 is that the objective function 1 ensures that a non-default enterprise has the highest score and a default enterprise has the lowest score, while the objective function 2 minimizes the overlap between the scores of a default enterprise and a non-default enterprise.

### Step 6: Constructing Constraints

Taking that “the sum of all index weights is 1, i.e.,

$${\sum }_{j = 1}^{m} {w}_{j} = {1}^{″}$$

and “the index weights are not negative, i.e., wj≥0” as two constraints.

In the patent, multi-objective programming models are constructed through the objective function 1 of step 4, the objective function 2 of step 5 and the two constraints of step 6, and optimal weight vector of a credit rating equation is derived, so as to ensure that default and non-default customers can be significantly distinguished by the score values of the credit rating equation, and guarantee that the rating result of the credit rating equation is that a non-default enterprise has the highest score and a default enterprise has the lowest score, thus minimizing the overlap between the two types of samples. A principle is shown in FIG. 2.

### Step 7: Solving The Optimal Weight Vector

Linearly weighting the first objective function obj1 and the second objective function obj2 in the multi-objective programming models at a ratio of 1:1 to obtain a single-objective function. Keeping the constraints unchanged, as described in step 6. Solving the single-objective programming model by a simplex method to obtain the decision variable “a group of weight vectors W*=(w₁*, w₂*, . . . , wₘ*)”. The weight solution result is directly displayed in an Excel interface.

The weight vector solution result is shown in Column 3 of Table 1.

### Step 8: Calculating Credit Rating Scores

Using the weight solution result wⱼ* in Column 3 of Table 1 and the standardized index data xᵢⱼ of step 2 to linearly weight and construct the credit rating equation, and calculating the credit scores

$${S}_{i} = {\sum }_{j = 1}^{m} {w}_{j}^{*} {x}_{ij} .$$

TABLE 2
Comparative Analysis of Weights

| | | (3) Weight of | (4) Weight Based | |
|---|---|---|---|---|
| (1) | | the Present | on Coefficient of | (5) Weight Based |
| S/N | (2) Index Layer | Invention wⱼ* | Variation wⱼ^{′} | on F-statistic wⱼ^{″} |
| 1 | X₁ Asset-Liability Ratio | 0 | 0.020 | 0.021 |
| 2 | X₂ Quick Ratio | 0.100 | 0.053 | 0.019 |
| . . . | . . . | . . . | . . . | . . . |
| 14 | X₁₄ Urban Per Capita Disposable | 0.314 | 0.012 | 0.083 |
| | Income | | | |
| 15 | X₁₅ Years of Experience in Relevant | 0.012 | 0.017 | 0.114 |
| | Industry | | | |
| . . . | . . . | . . . | . . . | . . . |
| 24 | X₂₄ Score of Mortgage and Pledge | 0.065 | 0.029 | 0.016 |
| | Guarantee | | | |
| 25 | J-T Statistic | 6.526 | 3.961 | 5.846 |

A comparative analysis is conducted between the weighting method of the present invention and the existing classical weighting methods. Column 3 of Table 2 is the weight obtained by the present invention, Column 4 is the weight obtained based on coefficient of variation, and Column 5 is the weight obtained based on F-statistic.

Method and standard for comparative analysis: the default identification ability of credit scores obtained after weighting is tested through J-T non-parametric test statistic. The larger the J-T test statistic is, the more the credit scores can distinguish between default and non-default customers, and the greater the default identification ability of the weight vectors is.

It can be known from the last row of Table 2 that the default identification ability of the weighting model established by the present invention (Z=6.526) is greater than that of the two commonly used combination weighting models in the existing studies, i.e., weight based on coefficient of variation (Z=3.961) and weight based on F-statistic (Z=5.846), which indicates that the weighting model established by the present invention is superior to the traditional weighting models in the existing studies in terms of default identification ability.

The present invention still has many embodiments. All the technical solutions formed by adopting equivalent replacement or equivalent transformation of “an optimal method for credit rating based on the maximum credit similarity” of the present invention fall within the protection scope of the present invention.

1. A method for determining optimal weight vector of credit rating based on the maximum default identification ability measured by approaching ideal points, comprising the following steps:
step 1: constructing a credit risk evaluation index system
first, removing redundant indexes that reflect information redundancy from mass-selection indexes through partial correlation analysis; and then, selecting indexes with an ability to significantly distinguish a default status from an index system retained after the above screening through Probit regression to obtain the credit risk evaluation index system;
step 2: importing data
importing index data with a significant distinguishing ability in step 1 and customer default status into an Excel file; standardizing the imported index data and converting the imported index data into data within the interval of [0,1] to eliminate the influence of dimension; wherein the customer default status is divided into 1 for a default customer and 0 for a non-default customer;
step 3: constructing a distance function
step 3.1, determining a positive ideal point and a negative ideal point: the positive ideal point represents a score obtained by weighting the maximum value of each index, i.e., the maximum value of the credit scores; since the maximum value after standardization of all index data is 1, the maximum value of the credit scores is 1, i.e., the positive ideal point S⁺=1;
the negative ideal point represents a score obtained by weighting the minimum value of each index, i.e., the minimum value of the credit scores; since the minimum value after standardization of all index data is 0, the minimum value of the credit scores is 0, i.e., the negative ideal point S⁻=0;
step 3.2, constructing the distance function: constructing a function
$${D}_{k}^{+} = d ( {S}_{k}^{( 0 )} , {S}^{+} ) = {( {\sum }_{j = 1}^{m} {w}_{j} {x}_{kj}^{( 0 )} - {S}^{+} )}^{2}$$
of the distances from credit scores Sₖ⁽⁰⁾ of a non-de^{f}ault enterprise to the positive ideal point S⁺; wherein wⱼ is an index weight and a decision variable to be solved, xₖⱼ⁽⁰⁾ is the standardized index data of a non-default ente^{r}prise in step 2, and S⁺ is the positive ideal point determined in step 3.1;
constructing a function
$${D}_{l}^{-} = d ( {S}_{l}^{( 1 )} , {S}^{-} ) = {( {\sum }_{j = 1}^{m} {w}_{j} {x}_{lj}^{( 1 )} - {S}^{-} )}^{2}$$
of the distances from credit scores Sₗ⁽¹⁾ of a default enterprise to the negative ideal point S⁻; wherein xₗⱼ⁽¹⁾ is the standardized index data of a default enterprise in step 2, and S⁻ is the negative ideal point determined in step 3.1;
step 4: constructing the first objective function
constructing an objective function 1 according to the minimum algebraic sum of the Euclidean distances Dₖ⁺ from credit scores of a non-default enterprise to a positive ideal point and the minimum algebraic sum of the Euclidean distances Dₗ⁻ from credit scores of a default enterprise to a negative ideal point, i.e.:
$$obj 1 \text{:} min {\sum }_{k = 1}^{{n}_{0}} {D}_{k}^{+} + C {\sum }_{l = 1}^{{n}_{1}} {D}_{l}^{-} \qquad ( 1 )$$
wherein n₀ is the number of non-default enterprises, C is a penalty coefficient, and n₁ is the number of default enterprises;
constructing a programming model by taking formula (1) as the first objective function to derive optimal weight vector of a credit rating equation; and
guaranteeing that the rating result of the credit rating equation makes a non-default enterprise have the highest score and a default enterprise have the lowest score, and that the default and non-default customers can be significantly distinguished by the credit scores;
step 5: constructing the second objective function
constructing the second objective function through the lowest dispersion degree of the “distances Dₖ⁺ from scores of a non-default enterprise to a positive ideal point” and the lowest dispersion degree of the “distances Dₗ⁻ from scores of a default enterprise to a negative ideal point”, i.e.:
$$obj 2 \text{:} min \sqrt{VAR ( {D}_{k}^{+} ) + VAR ( {D}_{l}^{-} )} = \sqrt{{\sum }_{k = 1}^{{n}_{0}} {( {D}_{k}^{+} - {\overline{D}}^{+} )}^{2} + {\sum }_{l = 1}^{{n}_{1}} {( {D}_{l}^{-} - {\overline{D}}^{-} )}^{2}} \qquad ( 2 )$$
wherein D̅⁺ is the average value of the distances Dₖ⁺ from scores of a non-default enterprise to a positive ideal point, and D̅⁻ is the average value of the distances Dₗ⁻ from scores of a default enterprise to a negative ideal point;
constructing a programming model by taking formula (2) as the second objective function to derive optimal weight vector of a credit rating equation; and
guaranteeing that the rating result of the credit rating equation makes the scores of a default enterprise and a non-default enterprise have the lowest dispersion degree within respective group, thus minimizing the overlap between the two types of samples;
the difference between the first objective function and the second objective function is that the first objective function ensures that a non-default enterprise has the highest score and a default enterprise has the lowest score, while the second objective function minimizes the overlap between the scores of a default enterprise and a non-default enterprise;
step 6: constructing constraints
taking that “the sum of all index weights is 1, i.e.,
$${\sum }_{j = 1}^{m} {w}_{j} = {1}^{″}$$
and “the index weights are not negative, i.e., wj≥0” as two constraints;
in the method, multi-objective programming models are constructed through the first objective function of step 4, the second objective function of step 5 and the two constraints; and optimal weight vector of a credit rating equation is derived, making the credit rating result satisfy that the scores of a non-default enterprise gather near the positive ideal point and the scores of a default enterprise gather near the negative ideal point, thus the gap between the scores of the two types of enterprises is maximized;
step 7: solving the optimal weight vector
linearly weighting the first objective function formula (1) and the second objective function formula (2) in the multi-objective programming models at a ratio of 1:1 to obtain a single-objective function programming model; keeping the constraints unchanged, and solving the single-objective programming model by a simplex method to obtain the decision variable “a group of weight vectors W*=(w₁*, w₂*, . . . , wₘ*)”; the weight solution result is directly displayed in an Excel interface;
step 8: calculating credit rating scores
using the weight solution result wⱼ* of step 4 and the standardized index data xᵢⱼ of step 2 to linearly weight and construct the credit rating equation, and calculating the credit scores
$${S}_{i} = {\sum }_{j = 1}^{m} {w}_{j}^{*} {x}_{ij} .$$
